(19) United States
(12) Patent Application Publication
(10) Pub. No.: US 2025/0243561 A1
(43) Pub. Date: Jul. 31, 2025

(54) METHOD FOR RECOVERING METAL FOR THE REGENERATING SPENT CATALYST

(71) Applicant: Hanseo University Academic Cooperation Foundation, Seosan-si (KR)

(72) Inventor: Hea Kyung PARK, Seoul (KR)

(21) Appl. No.: 18/680,009

(22) Filed: May 31, 2024

(30) Foreign Application Priority Data
Jan. 29, 2024 (KR) 10-2024-0012894

(51) Int. Cl. C22B 11/00; C22B 5/12

(52) U.S. Cl. CPC C22B 11/048; C22B 5/12

(57) ABSTRACT

The present invention relates to a method for recovering metal from a spent catalyst by generating RuO₄ gas by adding hypochlorous acid or hypochlorite to the spent catalyst and introducing a mixed gas of oxygen and ozone, and then reducing the gas.

### CROSS REFERENCE TO RELATED APPLICATION

The present application claims priority based on Korean Patent Application No. 10-2024-0012894, filed on Jan. 29, 2024, the entire content of which is incorporated herein for all purposes by this reference.

### BACKGROUND OF THE DISCLOSURE

### 1. Field of the Disclosure

The present invention relates to a method of recovering metal for the spent catalyst by generating RuO₄ gas by adding hypochlorous acid or hypochlorite to the spent catalyst and introducing a mixed gas of oxygen and ozone, and then reducing the gas.

### 2. Description of the Related Art

Hydrogen is a very clean fuel, only water is produced without generating carbon dioxide during combustion thereof, and electricity and heat can be produced at the same time with high efficiency when used as fuel for fuel cells. However, hydrogen cannot exist alone in nature, but exists in nature in a form combined with other elements, so hydrogen can be widely used as fuel only when technology development for extracting with high purity from them, transporting, and storing hydrogen is involved.

Ammonia is a hydrogen source that can stably exist by combining hydrogen and nitrogen, can be industrially produced in large quantities by the Haber-Bosch process, and has advantages in transportation and storage because it is easily liquefied. In addition, it has an eco-friendly advantage because only harmless nitrogen and hydrogen are produced during ammonia decomposition. The ammonia decomposition reaction is an endothermic reaction in which 2 moles of ammonia are produced with 3 moles of hydrogen as described in the following Reaction Formula 1.

2NH_{3↔}N₂+3H₂ <Reaction Formula 1>

Metals such as ruthenium and nickel are known to exhibit high catalytic activity for ammonia decomposition reactions. Ruthenium catalysts exhibit the highest activity for ammonia decomposition reactions, but they are very expensive rare metals, and recovering ruthenium from spent catalysts can promote the cyclic utilization of ruthenium resources, are very important in terms of resource saving and environmental protection, and have high economic value.

A method of refining ruthenium, which is a platinum group metal, from materials recovered from various kinds of spent catalysts includes operations of making the metal into a solution or a gas phase. Materials recovered from spent catalysts containing ruthenium have an extremely non-uniform ruthenium content. Therefore, the dissolution method depends on the properties of the initial material, in particular, the content of ruthenium, its chemical conditions, and the base material.

The noble metal catalyst in which a platinum group metal is supported on γ-aluminum oxide as a support is generally treated by a hydrometallurgical process to recover the noble metal when the catalyst is useless due to extremely low its catalytic activity. Here, the γ-aluminum oxide support is dissolved in sodium hydroxide solution or sulfuric acid, and the precious metal remains as an undissolved chemical residue.

The noble metal-containing catalyst on an insoluble support such as α-aluminum oxide, silicon dioxide or zeolite is processed by a pyrometallurgical process to recover the noble metal. In the pyrometallurgical process, the catalyst is converted into a melt at high temperature and then separated into its elemental constituents (Hydrocarbon Engineering July 2003, pages 48-53, and Hydrocarbon Engineering March 2004, pages 31-36). The recovery of precious metals from spent catalysts containing precious metals by the pyrometallurgical process is complicated and expensive.

One known method of recovering ruthenium from a supported catalyst is to obtain β-RuCl₃·xH₂O crystals using the method of “alkali melt-oxidative distillation”. Chinese Patent Application No. 2006-100520730 discloses a method for recovering ruthenium from a ruthenium catalyst supported in activated carbon, which is complicated in operation, has a high energy consumption, has a low product recovery rate, and has a long recycling period.

A method for processing a platinum group metal with an increased ruthenium content is known to obtain a ruthenium salt by sintering together with barium peroxide, grinding a cake, processing the same with muriatic acid, precipitating barium with sulfate, filtering the same, adding muriatic acid to evaporate a filtrate, adding nitric acid to the evaporated solution, separating and washing the useless metal hydroxides precipitation [Maslenitskij I. K., Chugaev L. V., Borbat V. F. and others. Metallurgy of precious metals. The edition 2. Under L. V. Chugaeva's edition. Moscow, publishing house “Metallurgy”, 1987, pages 411-412].

The drawback of this method is that a large amount of expensive barium peroxide is required, a large amount of power for sintering is required, device costs are high, manufacturing and evaporation of a solution are expensive, ruthenium is lost due to co-precipitation with barium sulfate, and thus efficiency is low and unsuitable for processing materials with low ruthenium content.

As described above, in the conventional method of recovering or purifying ruthenium metal, even though various process technologies have been proposed, a demand for process development for a metal recovery method for improving a product recovery rate has been continuously demanded from an industrial aspect.

### PRIOR ART DOCUMENT

### Patent Document

(Patent Document 1) Chinese Patent Application No. 2006-100520730

### Non-Patent Document

(Non-patent Document 1) Hydrocarbon Engineering July 2003, pages 48-53
(Non-patent Document 2) Hydrocarbon Engineering March 2004, pages 31-36
(Non-Patent Document 3) Under L. V. Chugaeva's edition. Moscow, publishing house “Metallurgy”, 1987, pages 411-412.

### SUMMARY OF THE DISCLOSURE

The conventional method for recovering ruthenium metal has a disadvantage in that the recovery rate is lowered because the loss of ruthenium is inevitable during a series of treatment processes. Therefore, the present disclosure is directed to providing a method for recovering ruthenium, which is capable of recovering ruthenium at a high recovery rate from a ruthenium spent catalyst by solving the problems of the prior art.

In order to achieve the above object, an embodiment of the present invention provides a method for recovering metal from a spent catalyst, the method including the steps of: (a) generating RuO₄ gas by adding hypochlorous acid or hypochlorite to a spent catalyst containing ruthenium and introducing a mixed gas of oxygen and ozone; (b) obtaining an H₃RuCl₆ solution by introducing the RuO₄ gas into a muriatic acid solution; (c) generating an H₂RuCl₆ solution by introducing an oxidizer into the H₃RuCl₆ solution; (d) introducing NH₄Cl into the H₂RuCl₆ solution and obtaining an (NH₄)₂RuCl₆ solid; and (e) obtaining ruthenium by reducing the (NH₄)₂RuCl₆ solid at a temperature of 450 to 800° C. using a mixed gas of hydrogen and nitrogen.

In a preferred embodiment of the present invention, the content of ozone in the mixed gas in Step (a) can be 5 to 20 vol %. In a preferred embodiment of the present invention, the RuO₄ gas in Step (b) can be introduced into a 3 to 8 mol/L muriatic acid solution.

In a preferred embodiment of the present invention, the temperature in Step (b) can be 0 to 15° C.

In a preferred embodiment of the present invention, the oxidizing agent in Step (c) can include one of ammonium chlorate, potassium chlorate, sodium chlorate, and magnesium chlorate.

In a preferred embodiment of the present invention, the H₂RuCl₆ solution in Step (d) can be heated to 60 to 90° C.

In a preferred embodiment of the present invention, the volume fraction of hydrogen in the mixed gas in Step (e) can be 1 to 20%.

In a preferred embodiment of the present invention, a pretreatment step of introducing a spent catalyst into an organic solvent and washing while stirring can be included before Step (a).

In a preferred embodiment of the present invention, the organic solvent can be any one selected from acetone, pyridine, hexafluoro isopropanol, methanol, ethanol, propanol, butanol, cyclohexane, toluene, and dichloromethane.

In a preferred embodiment of the present invention, the pretreatment step can be carried out at 0 to 150° C.

The method for recovering metal according to the present invention shows the effect of recovering ruthenium at a high recovery rate from a ruthenium spent catalyst.

### DESCRIPTION OF THE PREFERRED EMBODIMENTS

Unless otherwise defined, all technical and scientific terms used herein have the same meaning as commonly understood by those skilled in the art. In general, the nomenclature used herein is well known and commonly used in the art.

Terms such as “comprising,” “including,” “containing,” or “having” described in the specification refer to the presence of features, numerical values, steps, operations, components, parts, or combinations thereof described in the specification, and do not exclude the possibility that other features, numerical values, steps, operations, components, parts, or combinations thereof not mentioned can be present or added.

Hereinafter, preferred embodiments of a method for recovering metal from a spent catalyst according to the present invention will be described in detail.

The present invention relates to a method for recovering metal from a spent catalyst, wherein the method for recovering ruthenium comprises the steps of: (a) generating RuO₄ gas by adding hypochlorous acid or hypochlorite to a spent catalyst containing ruthenium and introducing a mixed gas of oxygen and ozone; (b) obtaining an H₃RuCl₆ solution by introducing the RuO₄ gas into a muriatic acid solution; (c) generating H₂RuCl₆ an solution by introducing an oxidizer into the H₃RuCl₆ solution; (d) introducing NH₄Cl into the H₂RuCl₆ solution and obtaining an (NH₄)₂RuCl₆ solid; and (e) obtaining ruthenium by reducing the (NH₄)₂RuCl₆ solid at a temperature of 450 to 800° C. using a mixed gas of hydrogen and nitrogen.

Here, a pretreatment step of adding a spent catalyst into an organic solvent and washing the same while stirring can be included before Step (a).

In a preferred embodiment, the organic solvent can be any one selected from acetone, pyridine, hexafluoro isopropanol, methanol, ethanol, propanol, butanol, cyclohexane, toluene, and dichloromethane.

In this case, the spent catalyst can be included in an amount of 1 to 20 parts by weight based on 100 parts by weight of the organic solvent. Preferably, 0.5 to 5 parts by weight can be provided. Within this range, the catalyst can be sufficiently stirred and washed to remove organic materials that inhibit activation by inducing fouling of the catalyst.

In a preferred embodiment, the pretreatment step can be carried out at 0 to 150° C. for 0.15 to 12 hours.

When the temperature in the stirring and washing step in Step (a) is less than 0° C., it is difficult to effectively remove the organic material causing fouling, and when the temperature is 150° C. or more, the washing organic solvent is easily evaporated, which is not suitable.

The stirring rate is 100 to 1000 rpm using a high speed magnetic stirrer, preferably 300 rpm.

In addition, the stirring and washing step can be provided once, and further, can be performed twice or more. When the number of washing is increased, the material fouled on the catalyst can be more smoothly removed, and thus the catalyst may further contribute to the recovery of the initial activity thereof. However, if it proceeds more than necessary, it is unreasonable in terms of time or cost, so it is preferably provided 2 to 4 times.

First, a mixed gas of oxygen and ozone is introduced into a spent catalyst including ruthenium that is pre-treated or not pre-treated while adding hypochlorous acid or hypochlorite to generate RuO₄ gas [Step (a)].

Here, the hypochlorous acid used to dissolve the ruthenium spent catalyst is not particularly limited, and any one selected from low-purity sodium hypochlorite, potassium hypochlorite, and calcium hypochlorite for industrial use can be used.

The amount of hypochlorous acid or hypochlorite added is preferably 100 to 500 parts by weight, more preferably 200 to 300 parts by weight of ruthenium catalyst. If the content of hypochlorous acid or hypochlorite is less than 100 parts by weight, ruthenium is not completely dissolved, and if the content exceeds 500 parts by weight, the liquid content becomes excessively large, which is not preferable.

In addition, the temperature of the ruthenium dissolution can be 10 to 100° C., preferably 50 to 90° C. When the dissolution temperature is less than 10° C., the dissolution rate is slow, and when the dissolution temperature exceeds 100° C., evaporation becomes severe, and thus the impurities contained in the hypochlorous acid are accompanied, which is not preferable.

In this case, a mixed gas of oxygen and ozone is introduced into the hypochlorous acid solution in which ruthenium is dissolved to convert unreacted ruthenium into ruthenium tetroxide, thereby increasing a recovery rate of ruthenium.

In a preferred embodiment, the content of ozone in the mixed gas in Step (a) can be 5 to 20 vol %.

The material of the device for dissolving ruthenium is preferably glass or the like, and those made of an organic material such as a polyethylene container or the like are not preferable because they react with the produced ruthenium tetroxide.

Subsequently, the RuO₄ gas obtained in Step (a) is introduced into the muriatic acid solution to obtain a H₃RuCl₆ solution [Step (b)].

In a preferred embodiment, the RuO₄ gas in Step (b) can be introduced into a 3 to 8 mol/L muriatic acid solution to completely dissolve the RuO₄ gas, thereby obtaining a H₃RuCl₆ solution.

In a preferred embodiment, the temperature in Step (b) can be 0 to 15° C. If it is out of the temperature range, the absorption amount of ruthenium decreases, which is not preferable.

In addition, oxidizing agent is introduced into the H₃RuCl₆ solution to produce a H₂RuCl₆ solution [Step (c)].

In a preferred embodiment, the oxidizing agent in Step (c) can include one of ammonium chlorate, potassium chlorate, sodium chlorate, and magnesium chlorate.

Specifically, Mg(ClO₃)₂ as an oxidant is slowly introduced into the H₃RuCl₆ solution, and the H₃RuCl₆ solution is stirred for 15 hours to completely oxidize the H₃RuCl₆ solution, thereby producing a H₂RuCl₆ solution.

The (NH₄)₂RuCl₆ solid was obtained by introducing NH₄Cl into the H₂RuCl₆ solution [Step (d)].

In a preferred embodiment, the H₂RuCl₆ solution in Step (d) can be heated to 60 to 90° C.

Specifically, after the H₂RuCl₆ solution is heated to 90° C. and the H₂RuCl₆ solution is stirred at 100 r/min for 25 hours to obtain a (NH₄)₂RuCl₆ precipitate, the H₂RuCl₆ solution is filtered to obtain a filter cake, the filter cake is washed with an ethanol solution to remove impurities and a muriatic acid on the filter cake, and the filter cake is dried to obtain a (NH₄)₂RuCl₆ solid.

Finally, the (NH₄)₂RuCl₆ solid was reduced at a temperature of 450 to 800° C. by using a mixed gas of hydrogen and nitrogen to obtain ruthenium [Step (e)].

In a preferred embodiment, the volume fraction of hydrogen in the mixed gas in Step (e) can be 1 to 20%.

Specifically, the (NH₄)₂RuCl₆ solid can be reduced at a temperature of 500-700° C. using a mixed gas of hydrogen and nitrogen to obtain a ruthenium metal.

The high-purity ruthenium powder thus obtained can be used as a desired material for forming a thin film, for example, as a sputtering target, by a sintering method, such as hot press.

Hereinafter, the present invention will be described according to embodiments, but the contents of the present invention are not limited to the embodiments.

### Pretreatment Process

580 g of 2%-Ru/Al₂O₃ was added to acetone at room temperature and washed with stirring.

### Example 1

580 g of washed 2%-Ru/Al₂O₃ was added to a flask, and 35 L of sodium hypochlorite having an effective chlorine concentration of 5% was slowly added thereto to dissolve ruthenium powder. In addition, the solution was heated to 80° C. to generate RuO₄ gas. At this time, oxygen gas containing 7 vol % of ozone was blown at the same time.

By introducing the RuO₄ gas into a 6 mol/L muriatic acid solution to completely absorb the RuO₄ gas, a H₃RuCl₆ solution is obtained, and the temperature at this time (first temperature) is 10° C.

After 0.63 g of NaClO₃ powder as an oxidant is slowly introduced into the H₃RuCl₆ solution, and the H₃RuCl₆₆ solution is stirred for 0.5 hours to completely oxidize the H₃RuCl₆₆ solution to generate H₂RuCl₆, 3.81 g of NH₄Cl is introduced into the H₂RuCl₆ solution, the H₂RuCl₆ solution is heated to 90° C. (second temperature), and the H₂RuCl₆ solution is stirred for 1.5 hours at 200 r/min to obtain a (NH₄)₂RuCl₆ precipitate, the H₂RuCl₆ solution is filtered to obtain a filter cake, the filter cake is washed with an ethanol solution to remove impurities and muriatic acid on the filter cake, and the filter cake is dried to obtain a (NH₄)₂RuCl₆ solid. The (NH₄)₂RuCl₆ solid is reduced at a temperature of 650° C. using a mixed gas of hydrogen and nitrogen to obtain a ruthenium metal, wherein the volume fraction of hydrogen in the mixed gas is 5%.

### Example 2

It is the same as in Example 1 except that oxygen gas containing 10 vol % of ozone is blown in the process of generating RuO₄ gas.

### Comparative Example 1

580 g of washed 2%-Ru/Al₂O₃ was added to a flask, and 35 L of sodium hypochlorite having an effective chlorine concentration of 5% was slowly added thereto to dissolve ruthenium powder. The solution was heated to 80° C. to generate RuO₄ gas. At this time, oxygen gas containing 2 vol % of ozone was blown at the same time.

By completely absorbing the RuO₄ gas with the RuO₄ gas introducing into a 6 mol/L muriatic acid solution, a H₃RuCl₆ solution is obtained, wherein the temperature (first temperature) is 10° C.

After 0.63 g of NaClO3 powder as an oxidant is slowly introduced into the H₃RuCl₆ solution, the H₃RuCl₆ solution is stirred for 0.5 hours to completely oxidize the H₃RuCl₆ solution to produce H₂RuCl₆, 3.81 g of NH₄Cl is introduced into the H₂RuCl₆ solution, the H₂RuCl₆ solution is heated to 90° C., and the H₂RuCl₆ solution is stirred for 1.5 hours at 200 r/min to obtain an (NH₄)₂RuCl₆ precipitate. Then, the H₂RuCl₆ solution is filtered to obtain a filter cake, the filter cake is washed with an ethanol solution to remove impurities and muriatic acid on the filter cake, and the filter cake is dried to obtain an (NH₄)₂RuCl₆ solid. The (NH₄)₂RuCl₆ solid is reduced at a temperature of 650° C. using a mixed gas of hydrogen and nitrogen to obtain a ruthenium metal, wherein the volume fraction of hydrogen in the mixed gas is 5%.

### Comparative Example 2

It is the same as in Example 1 except that oxygen gas containing 25 vol % of ozone is blown in the process of generating RuO₄ gas.

### Comparative Example 3

The same procedure as in Example 1 was performed except that the RuO₄ gas was introduced into a 2 mol/L muriatic acid solution.

### Comparative Example 4

The same procedure as in Example 1 was performed except that the RuO₄ gas was introduced into the 12 mol/L muriatic acid solution.

### Comparative Example 5

It is the same as Example 1 except that the first temperature when introducing RuO₄ gas into the muriatic acid solution is 25° C.

### Comparative Example 6

It is the same as in Example 1 except that the second temperature for heating the H₂RuCl₆ solution is room temperature (25° C.).

### Comparative Example 7

It is the same as Example 1 except that the second temperature for heating the H₂RuCl₆ solution is 120° C.

TABLE 1

| | | Muriatic acid | | | |
|---|---|---|---|---|---|
| | Ozone | concentration | First | Second | Recovery |
| | (vol %) | (mol/L) | temperature | temperature | rates (%) |
| Comparative | 2 | 6 | 10 | 90 | 84 |
| example 1 | | | | | |
| Example 1 | 7 | 6 | 10 | 90 | 97 |
| Example 2 | 10 | 6 | 10 | 90 | 98 |
| Comparative | 25 | 6 | 10 | 90 | 86 |
| example 2 | | | | | |
| Comparative | 7 | 2 | 10 | 90 | 78 |
| Example 3 | | | | | |
| Comparative | 7 | 12 | 10 | 90 | 80 |
| example 4 | | | | | |
| Comparative | 7 | 6 | 25 | 90 | 87 |
| example 5 | | | | | |
| Comparative | 7 | 6 | 10 | 25 | 85 |
| example 6 | | | | | |
| Comparative | 7 | 6 | 10 | 120 | 79 |
| example 7 | | | | | |

As shown in Table 1, in the metal recovery processes according to Examples 1 and 2, ruthenium was obtained at a higher recovery rate than the metal recovery process according to Comparative Example 1 to 7.

Although the preferred embodiment of the present invention has been described above, the present invention is not limited thereto, and can be modified in various ways within the scope of the claims, the detailed description of the invention, and the accompanying drawings, and it is natural that the present invention belongs to the scope of the present invention.

1. A method for recovering metal from a spent catalyst, the method comprising the steps of:
(a) generating RuO₄ gas by adding hypochlorous acid or hypochlorite to a spent catalyst containing ruthenium and introducing a mixed gas of oxygen and ozone;
(b) obtaining an H₃RuCl₆ solution by introducing the RuO₄ gas into a hydrochloric acid solution;
(c) generating an H₂RuCl₆ solution by introducing an oxidizer into the H₃RuCl₆ solution;
(d) introducing NH₄Cl into the H₂RuCl₆ solution and obtaining an (NH₄)₂RuCl₆ solid; and
(e) obtaining ruthenium by reducing the (NH₄)₂RuCl₆ solid at a temperature of 450 to 800° C. using a mixed gas of hydrogen and nitrogen.

2. The method for recovering metal from a spent catalyst of claim 1, wherein the content of ozone in the mixed gas in Step (a) is 5 to 20 vol %.

3. The method for recovering metal from a spent catalyst of claim 1, wherein the RuO₄ gas in Step (b) is introduced into a 3 to 8 mol/L hydrochloric acid solution.

4. The method for recovering metal from a spent catalyst of claim 1, wherein the temperature in Step (b) is 0 to 15° C.

5. The method for recovering metal from a spent catalyst of claim 1, wherein the oxidizing agent in Step (c) comprises one of ammonium chlorate, potassium chlorate, sodium chlorate, and magnesium chlorate.

6. The method for recovering metal from a spent catalyst of claim 1, wherein the H₂RuCl₆ solution in Step (d) is heated to 60 to 90° C.

7. The method for recovering metal from a spent catalyst of claim 1, wherein the volume fraction of hydrogen in the mixed gas in Step (e) is 1 to 20%.

8. The method for recovering metal from a spent catalyst of claim 1, the method comprising a pretreatment step of introducing the spent catalyst into an organic solvent and washing the spent catalyst while stirring, before Step (a).

9. The method for recovering metal from a spent catalyst of claim 8, wherein the organic solvent is any one selected from acetone, pyridine, hexafluoro isopropanol, methanol, ethanol, propanol, butanol, cyclohexane, toluene, and dichloromethane.

10. The method for recovering metal from a spent catalyst of claim 8, wherein the pretreatment step is performed at 0 to 150° C.
